(19) United States
(12) Patent Application Publication
(10) Pub. No.: US 2014/0031990 A1
(43) Pub. Date: Jan. 30, 2014

(54) HVAC CONTROLLER AND A HVAC SYSTEM EMPLOYING DESIGNATED COMFORT SENSORS WITH PROGRAM SCHEDULE EVENTS

(71) Applicant: Amanda Filbeck, Guthrie, OK (US)

(72) Inventor: Amanda Filbeck, Guthrie, OK (US)

(21) Appl. No.: 13/559,462

(22) Filed: Jul. 26, 2012

(51) Int. Cl. G05D 23/19

(52) U.S. Cl. 700/276

(57) ABSTRACT

A HVAC controller, a computer program product and a HVAC system are provided that advantageously employ comfort sensors with program schedule events for operating a HVAC system. In one embodiment, the controller includes: (1) an interface configured to receive programming data for the controller and (2) a memory configured to associate a program schedule event for the HVAC system to at least one comfort sensor of the enclosed space according to the programming data.

### TECHNICAL FIELD

This application is directed, in general, to heating, ventilating and air conditioning (HVAC) systems and, more specifically, to a controlling the operation of an HVAC system.

### BACKGROUND

Heating, ventilating and air conditioning (HVAC) systems can be used to regulate the environment within an enclosed space. Typically, an air blower is used to pull air from the enclosed space into the HVAC system through ducts and push the air back into the enclosed space through additional ducts after conditioning the air (e.g., heating, cooling or dehumidifying the air). Various types of HVAC systems may be used to provide conditioned air for enclosed spaces such as residences and commercial property.

Each HVAC unit typically includes a HVAC controller that directs the operation of the HVAC unit. Some HVAC systems are zoned systems that use dampers to control air flow through an enclosed space. In such systems, the HVAC controller manipulates the dampers of the HVAC system to direct the air flow into or away from desired portions of the enclosed space.

### SUMMARY

One aspect provides a controller for a HVAC system of an enclosed space. In one embodiment, the controller includes: (1) an interface configured to receive programming data for the controller and (2) a memory configured to associate a program schedule event for the HVAC system to at least one comfort sensor of the enclosed space according to the programming data.

In another aspect, a computer-usable medium is disclosed. In one embodiment, the computer-usable medium has non-transitory computer readable instructions stored thereon for execution by a processor to perform a method for operating a HVAC system of an enclosed space, including: (1) receiving programming data that indicates an association of at least one comfort sensor of the enclosed space to a program schedule event of the HVAC system and (2) assigning the at least one comfort sensor to the program schedule event.

In yet another aspect, a HVAC system is disclosed. In one embodiment, the HVAC system includes: (1) heating, cooling and blowing (HCB) components and (2) a controller coupled to the HCB components and configured to manage operation thereof. In the embodiment, the controller has: (2A) a memory configured to associate a program schedule event for the HVAC system to at least one comfort sensor of the enclosed space and (2B) a processor configured to operate the HVAC system according to the program schedule event and the at least one comfort sensor.

### BRIEF DESCRIPTION

Reference is now made to the following descriptions taken in conjunction with the accompanying drawings, in which:

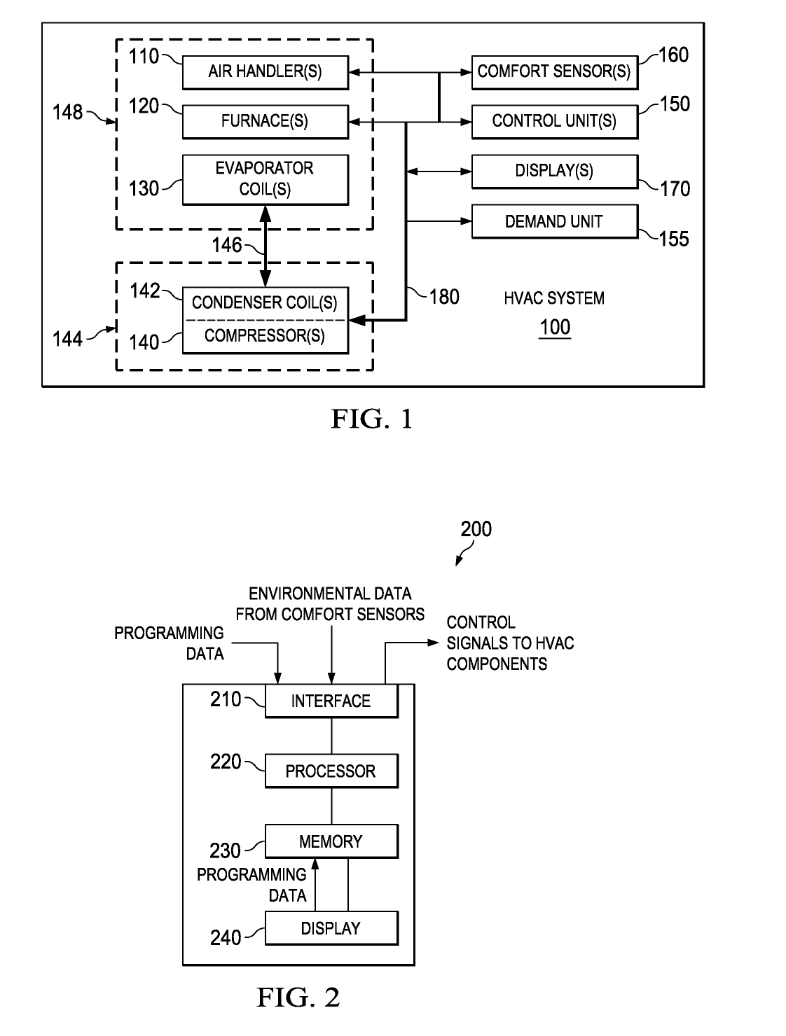

FIG. 1 is a high-level block diagram of an embodiment of a HVAC system constructed according to the principles of the disclosure;

FIG. 2 illustrates a block diagram of an embodiment of a controller constructed according to the principles of the disclosure;

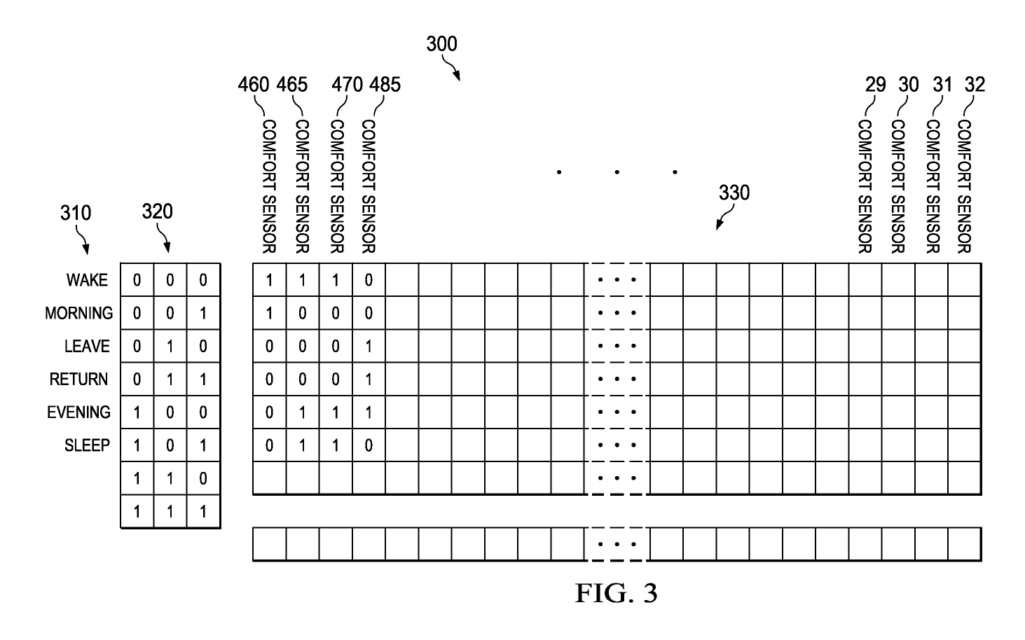

FIG. 3 illustrates an embodiment of data table configured to associate comfort sensors to program schedule events according to the principles of the disclosure;

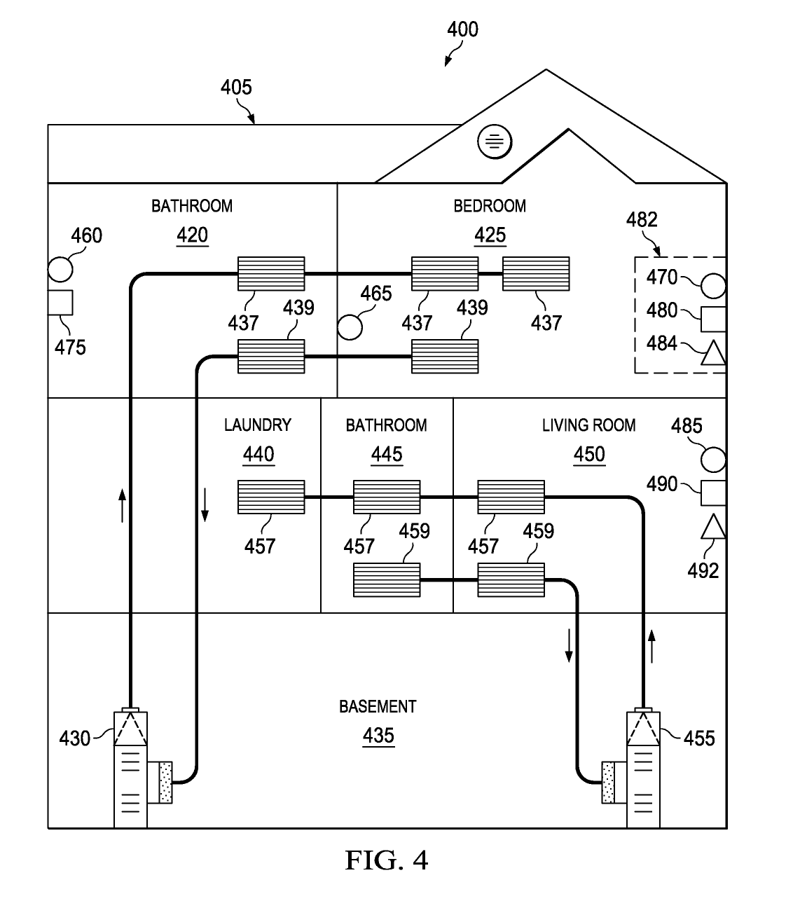

FIG. 4 illustrates an example of an embodiment of an HVAC system in an enclosed space that is constructed according to the principles of the disclosure; and

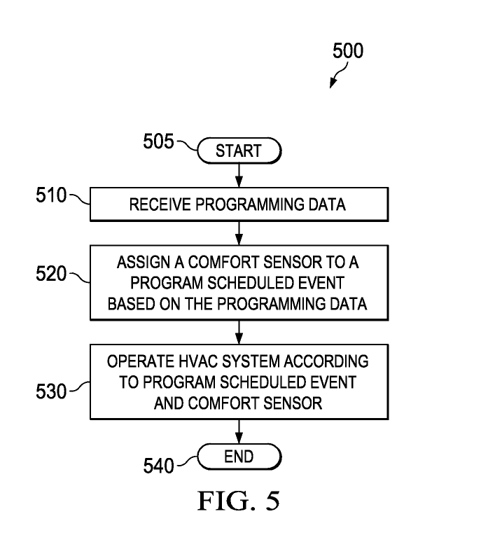

FIG. 5 is a flow diagram of an embodiment of a method of operating a HVAC system of an enclosed space carried out according to the principles of the disclosure.

### DETAILED DESCRIPTION

Employing dampers in a zoned system adds complexity and cost to HVAC systems. Additionally, the dampers can result in increased maintenance and provide additional points-of-failure for HVAC systems. As such, customer satisfaction can be affected.

Disclosed herein is a HVAC system that provides the benefits of a zoned system without the need for dampers. Instead, an environmental sensor or sensors, hereinafter referred to as a comfort sensor or sensors, within an enclosed space is used as a basis for program schedule events of the HVAC system to indicate a selected area of the enclosed space for a particular program schedule event. Thus, the disclosure provides an HVAC system that allows selecting which area of an enclosed space will typically be occupied during a program schedule event and, therefore, provide conditioned air based on a comfort sensor in that selected area. Accordingly, the HVAC system has a type of zoned system without requiring dampers.

For example, an HVAC system for an enclosed space includes a controller that initiates the HVAC system in response to a designated input, e.g., a thermostat call. The controller is configured to direct the operation of the HVAC system according to program schedule events such as “Sleep.” For Sleep a comfort sensor in a bedroom of the enclosed space has been assigned in a memory of the controller. Thus, the controller directs the operation of the HVAC system for Sleep based on the input of the comfort sensor in the bedroom. If the desired temperature for Sleep is 72 degrees, the controller will direct the HVAC system to maintain the desired temperature of 72 degrees according to the bedroom comfort sensor.

FIG. 1 is a high-level block diagram of an embodiment of a HVAC system, 100, constructed according to the principles of the disclosure. The HVAC system 100 is a networked HVAC system configured to condition air for an enclosed space. In one embodiment, the system 100 is configured to provide ventilation and therefore includes one or more air handlers 110. In an alternative embodiment, the system 100 is configured to provide heating and therefore includes one or more furnaces 120, typically associated with the one or more air handlers 110. In an alternative embodiment, the system 100 is configured to provide cooling and therefore includes one or more refrigerant evaporator coils 130, typically associated with the one or more air handlers 110. Such embodiment of the system 100 also includes one or more compressors 140 and associated condenser coils 142, which are typically associated with one or more so-called “outdoor units” 144. The one or more compressors 140 and associated condenser coils 142 are typically connected to an associated evaporator coil 130 by a refrigerant line 146. In an alternative embodiment, the system 100 is configured to provide ventilation, heating and cooling, in which case the one or more air handlers 110, furnaces 120 and evaporator coils 130 are associated with one or more “indoor units” 148, e.g., basement or attic units that may also include an air handler.

For convenience in the following discussion, a demand unit 155 is representative of the various units exemplified by the air handler 110, furnace 120, and compressor 140, and more generally includes an HVAC component that provides a service in response to control by the controller 150. The service may be, e.g., heating, cooling, humidification, dehumidification, or air circulation. A demand unit 155 may provide more than one service, and if so, one service may be a primary service, and another service may be an ancillary service. For example, for a heating unit that also circulates air, the primary service may be heating cooling, and the ancillary service may be air circulation (e.g. by a blower).

One or more controllers 150 control one or more of the one or more air handlers 110, the one or more furnaces 120 and/or the one or more compressors 140 to regulate the temperature of the enclosed space, at least approximately. In various embodiments, the one or more displays 170 can provide additional functions such as operational, diagnostic and status message display and an attractive, visual interface that allows an installer, user or repairman to perform actions with respect to the system 100 more intuitively. Herein, the term “operator” will be used to refer collectively to any of the installer, the user and the repairman unless clarity is served by greater specificity.

The controller 150 is configured to control operation of the HVAC system 100 according to program schedule events that allow programming of event times, temperature setpoints and fan mode for defined periods such as Sleep, Wake, Return, etc. As such, the controller 150 includes a memory that associates the various program schedule events to their associated attributes including temperature setpoints, operating times, etc. The memory can include a data table for associating program schedule events with their attributes. The display or displays 170 can include a programs tab that advances a user to a programs schedule screen. The programs schedule screen can be configured to allow for viewing/editing/enabling program schedule events (e.g., temperature setpoints, system modes and fan modes) in the HVAC system 100. The programs screen can also allow programming of event times, temperature setpoints and fan mode for the defined periods.

One or more separate comfort sensors 160 may be associated with the one or more controllers 150 and may also optionally be associated with one or more displays 170. The one or more comfort sensors 160 provide current information, environmental data, about environmental conditions inside of the conditioned space, such as temperature, humidity and air quality to the one or more controller 150. An individual comfort sensor 160 may be physically located within a same enclosure or housing as the controller 150, in a manner analogous with a conventional HVAC thermostat. In such cases, the commonly housed comfort sensor 160 may be addressed independently. However, the one or more comfort sensors 160 may be located separately and physically remote from the one or more control units 150. Also, an individual controller 150 may be physically located within a same enclosure or housing as a display 170, again analogously with a conventional HVAC thermostat. In such embodiments, the commonly housed controller 150 and display 170 may each be addressed independently. However, one or more of the displays 170 may be located within the system 100 separately from and/or physically remote to the control units 150. The one or more displays 170 may include a screen such as a liquid crystal or OLED display (not shown).

The comfort sensor 160 can be a Comfort Sensor available from Lennox Industries Inc. of Richardson, Tex., including model numbers 18W65, 18W66, 18W67 and 18W68. The controller 150 can include the functionality and be configured to operate as an icomfort Touch® Touchscreen Thermostat also available from Lennox Industries Inc., with the additional functionality of associating program schedule events with comfort sensors.

Although not shown in FIG. 1, the HVAC system 100 may include one or more heat pumps in lieu of or in addition to the one or more furnaces 120, and one or more compressors 140. One or more humidifiers or dehumidifiers may be employed to increase or decrease humidity.

Finally, a data bus 180, which in the illustrated embodiment is a serial bus, couples the one or more air handlers 110, the one or more furnaces 120, the one or more evaporator condenser coils 142 and compressors 140, the one or more control units 150, the one or more remote comfort sensors 160 and the one or more displays 170 such that data may be communicated therebetween or thereamong. All or some parts of the data bus 180 may be implemented as a wired or wireless network.

The data bus 180 in some embodiments is implemented using the Bosch CAN (Controller Area Network) specification, revision 2, and may be synonymously referred to herein as a residential serial bus (RSBus) 180. The data bus 180 provides communication between or among the aforementioned elements of the network 200. It should be understood that the use of the term “residential” is nonlimiting; the network 200 may be employed in any enclosed space whatsoever, fixed or mobile. Other embodiments of the data bus 180 are also contemplated, including e.g., a wireless bus, as mentioned previously, and 2-, 3- or 4-wire networks, including IEEE-1394 (Firewire™, I.LINK™, Lynx™), Ethernet, Universal Serial Bus (e.g., USB 1.x, 2.x, 3.x), or similar standards. In wireless embodiments, the data bus 180 may be implemented, e.g., using Bluetooth™, Zibgee or a similar wireless standard. One skilled in the art will understand that associating comfort sensors to program schedule events as disclosed herein is not tied to a particular type of data bus or connection between the various components of an HVAC system.

FIG. 2 illustrates a block diagram of an embodiment of a controller 200 constructed according to the principles of the disclosure. The controller 200 is configured to direct the operation of or at least part of the operation of an HVAC system, such as the HVAC system 100. As such, the controller 200 is configured to generate control signals that are transmitted to the various components to direct the operation thereof. The controller 200 may generate the control signals in response to feedback data that is received from various sensors and/or components of the HVAC system, such as comfort sensors. The controller 200 includes an interface 210 that is configured to receive and transmit the feedback data and control signals. The interface 210 is also configured to receive programming data for directing the operation of a HVAC system. The interface 210 may be a conventional interface that is used to communicate (i.e., receive and transmit) data for a controller, such as a microcontroller.

The controller 200 also includes a processor 220, a memory 230 and a display 240. The memory 230 may be a conventional memory typically located within a controller, such as a microcontroller, that is constructed to store data and computer programs. The memory 230 may store operating instructions to direct the operation of the processor 220 when initiated thereby. The operating instructions may correspond to algorithms that provide the functionality of the operating schemes disclosed herein. For example, the operating instructions may correspond to the algorithm or algorithms that implement the method illustrated in FIG. 5. The processor 220 may be a conventional processor such as a microprocessor. The controller 200 also includes a display 240 for visually providing information to a user and allow interaction with the user for inputting programming data. The interface 210, processor 220 memory 230 and display 240 may be coupled together via conventional means to communicate information. The controller 200 may also include additional components typically included within a controller for a HVAC system, such as a power supply or power port.

The memory 220 is configured to associate a program schedule event for an HVAC system to at least one comfort sensor of an enclosed space associated with the HVAC system according to programming data received via the interface 210. In one embodiment, the memory 220 includes a data table configured to associate the program schedule event to a comfort sensor.

The interface 210 and memory 220 are configured to receive programming data to associate multiple comfort sensors to one or multiple program schedule events. FIG. 3 provides an example of a data table used in an embodiment to store associations of comfort sensors with program schedule events.

The processor 230 is configured to operate the HVAC system according to the program schedule event and the comfort sensor or sensors that are assigned thereto. In one embodiment, the processor 230 is configured to operate the HVAC system according to a program schedule event and a temperature determined by a comfort sensor. In other embodiments, another environmental condition, such as humidity, determined by the comfort sensor may be used along with a program schedule event to control the operation of the HVAC system. In some embodiments, multiple environmental conditions determined by a comfort sensor or sensors may be employed. For example, humidity and temperature may be used with program schedule events. In some embodiments, multiple comfort sensors are assigned to a single program schedule event. As such, the processor 230 is configured to determine an average of the environmental data determined by the multiple comfort sensors to use as a basis for operating the HVAC system with respect to a program schedule event. For example, the processor 230 can be configured to receive various temperature readings from multiple comfort sensors and determine an average of the various readings as a basis for the program schedule event.

FIG. 3 illustrates an embodiment of data table 300 configured to associate comfort sensors to program schedule events according to the principles of the disclosure. The data table 300 can be stored in a memory, such as memory 220 of FIG. 2. The data table 300 can be constructed in a conventional data structure of a conventional memory typically included with HVAC controllers.

The data table 300 includes three sections. The first section 310 includes program schedule events. The second section 320 includes schedule event identifiers. The third section 330 includes comfort sensor assignments.

The program schedule events 310 include Wake, Morning, Leave, Return, Evening and Sleep. The program schedule events allow an operator, such as a user, to designate a desired environmental condition, such as a temperature, for a particular event. An operator can input programming data for assigning the various attributes to the program schedule events. A user interface, such as a keypad or keyboard can be used with the interface 210 for entering programming data. The display 240 can also be used.

Activation for the HVAC system according to a program schedule event can be done manually via a user interacting with the display 240. For example, the user can push a button on the display to activate Sleep when the user is going to bed. Alternatively, a designated time can be associated with the various program schedule events. As such, a user can enter a time for the program schedule events to begin. For example, a user may desire a temperature of 70 degrees when going to sleep. An HVAC controller, such as the controller 200, is configured to operate the HVAC system to obtain the desired temperature of 70 degrees for Sleep.

The schedule event identifiers 320 include three columns with each column representing a bit for designating the particular program schedule event. The three bit columns can be used to identify up to eight different program schedule events. One skilled in the art will understand that different program schedule events than those of FIG. 3 and a different number of program schedule events can be used. Additionally, some HVAC systems can be configured to have more or less than eight different program schedule events. For example, some systems may designate four bits for identifying program schedule events.

The comfort section 330 is a 32 bit field with each bit identifying a particular comfort sensor. In data table 300, a total of 32 comfort sensors can be assigned to the various program schedule events. One skilled in the art will understand that systems can include more or less comforts sensors than 32 for assignment. In FIG. 3, four comfort sensors that correspond to FIG. 4 are specifically denoted and assigned. A single bit, “1,” can be used to designate assigned comfort sensors. Those comfort sensors that are not assigned can be denoted with a “0” in data table 3.

FIG. 4 illustrates an example of an embodiment of an HVAC system 400 constructed according to the principles of the disclosure. A residence 405 includes a bathroom 420, a bedroom 425, a basement 435, a laundry room 440, a bathroom 445 and a living room 450. A demand unit 430 and a demand unit 455, e.g., gas or electric furnaces, located in the basement 435 provide heated or cooled air to the residence via source vents 447, return vents 439 and source vents 457 and return vents 459, respectively.

The residence 405 also includes comfort sensors 460, 465, 470, user interfaces 475, 480 and a controller 484. The residence also includes a comfort sensor 485, a user interface 490, and a controller 492. The controller 492 may be optionally omitted with the controller 484 configured to control heating and cooling demands for the residence. In FIG. 4, the comfort sensors 460, 465, 470, user interfaces 475, 480 and the demand unit 430 are networked to form a first subnet. The comfort sensor 485, user interface 490 and demand unit 455 are networked to form a second subnet. As such, controller 484 and controller 492 can be considered subnet controllers. In some embodiments, the two subnets can be connected to form a single network.

In the illustrated embodiment, the user interfaces 475, 480 are physically associated with the demand unit 430, and the user interface 490 is physically associated with the demand unit 455. Furthermore, the controller 484 is physically associated with the demand unit 430, and the controller 492 is physically associated with the demand unit 455. Herein, a user interface or controller is physically associated with a demand unit when the subject user interface or subnet controller is located in a space that is conditioned by that demand unit. Thus, e.g., the controller 484 is not physically associated with the demand unit 455. A controller or user interface may be logically associated with a particular demand unit, even if the controller or user interface is not physically associated therewith. By logically associated, it is meant that the controller or user interface may operate in some configurations to control the ambient conditions of the residence 405 with which the controller or user interface is logically associated.

The comfort sensors 460, 465, 470 are positioned in any location at which a user wishes to locally sense an environmental condition and generate environmental data representing the condition. In some cases a particular comfort sensor is collocated with a user interface, such as, e.g. the comfort sensor 470 and user interface 480. A collocated comfort sensor and user interface may be logical devices of a single physical unit, or may be discrete physical units. For example, it may be convenient for the comfort sensor 470 and the user interface 480 to be located in an enclosure 482 to present to the operator a familiar look and feel associated with conventional thermostats. Optionally, the controller 484 is also located within the enclosure 482. As described previously, the comfort sensor 470 and the user interface 480 remain independently addressable in the network even when housed in a same enclosure. In other cases a comfort sensor is located without being collocated with a user interface. One example is the comfort sensor 465. As described further below, any of the user interfaces 475, 480, 490 may be collocated with an active controller, which may control any demand unit in the HVAC network to maintain an environmental condition measured by any of the comfort sensors 460, 465, 470, 485.

Returning now to FIG. 3, comfort section 330 includes comfort sensors 460, 465, 470 and 485 of FIG. 4, respectively. According to data table 300, comfort sensors 460, 465 and 470 are assigned to the Wake program schedule event. Comfort sensor 460 is assigned to the Morning program schedule event and comfort sensor 485 is assigned to both the Leave and the Return program schedule events. For the Evening program schedule event, comfort sensors 465, 470 and 485 are assigned. Comfort sensors 465 and 470 are assigned for the Sleep program schedule event. Based on the assignments of data table 300, designated comfort sensors monitor a desired environmental condition for a particular area of the enclosed space 405 for each of the program schedule events. Thus, considering temperature for the desired environmental condition, the temperature detected by the comfort sensor 460 in the bathroom 420 is used as a basis for the Morning program schedule event. For the Evening program schedule event, an average of the temperatures detected by the comfort sensors 465, 470 and 485 are used as a basis. One controller, such as controller 484 can be configured to determine the average temperature of the comfort sensors 465, 470 and 485. The controllers 484 and 492 can communicate via a data bus, such as data bus 180, to determine the average temperature. In one embodiment, one of the controllers can be used for operating the HVAC system 400 according to the program schedule events and direct the operation of the other controller. In some embodiments, a single controller could be used for the HVAC system.

FIG. 5 is a flow diagram of an embodiment of a method 500 of operating a HVAC system of an enclosed space carried out according to the principles of the disclosure. The method 500 may be carried out under the direction of a computer program product. In one embodiment, a controller of a HVAC system is employed to carry out the method 500. A processor of the controller can be directed by a computer program product stored on a memory of the controller to perform the various steps of the method 500. The method 500 begins in a step 505.

In a step 510, programming data is received that indicates an association of at least one comfort sensor of the enclosed space to a program schedule event of the HVAC system. In one embodiment, the programming data indicates an association of multiple comfort sensors of the enclosed space to a program schedule event. Additionally, a single comfort sensor can be associated to multiple program schedule events by the programming data.

In a step 520, the comfort sensor is assigned to a program schedule event. In one embodiment, assigning includes mapping the comfort sensor to the program schedule event in a data table. In one embodiment, assigning includes assigning multiple comfort sensors to a single program schedule event. An operator can also change the assignments of comfort sensors to program schedule events. Additions, deletions and changes can also be made to the assignments. As such, new comfort sensors and program schedule events can be added. Additional programming data can be received for editing the assignments.

In a step 530, HVAC system is operated based on the program schedule event and the comfort sensor. In one embodiment, the HVAC system is operated based on comfort data determined by the comfort sensor. In embodiments where multiple comfort sensors are assigned to the program schedule event, the HVAC system is operated based on the multiple comfort sensors. For example, an average of the environmental data sensed by the multiple comfort sensors can be used to operate the HVAC system according to the program schedule event. The method 500 ends in a step 540.

The above-described methods may be embodied in or performed by various conventional digital data processors, microprocessors or computing devices, wherein these devices are programmed or store executable programs of sequences of software instructions to perform one or more of the steps of the methods, e.g., steps of the method of FIG. 5. The software instructions of such programs may be encoded in machine-executable form on conventional digital data storage media that is non-transitory, e.g., magnetic or optical disks, random-access memory (RAM), magnetic hard disks, flash memories, and/or read-only memory (ROM), to enable various types of digital data processors or computing devices to perform one, multiple or all of the steps of one or more of the above-described methods, e.g., one or more of the steps of the method of FIG. 5. Additionally, an apparatus, such as dedicated HVAC controller, may be designed to include the necessary circuitry to perform each step of the methods of FIG. 5 and include a memory to store the data table such as the data table 300.

Those skilled in the art to which this application relates will appreciate that other and further additions, deletions, substitutions and modifications may be made to the described embodiments.

What is claimed is:

1. A controller for a heating, ventilating and air conditioning (HVAC) system of an enclosed space, comprising:
an interface configured to receive programming data for said controller; and
a memory configured to associate a program schedule event for said HVAC system to at least one comfort sensor of said enclosed space according to said programming data.

2. The controller as recited in claim 1 wherein said memory includes a data table configured to associate said program schedule event to said at least one comfort sensor.

3. The controller as recited in claim 1 wherein said memory is configured to associate multiple comfort sensors of said enclosed space to said program schedule event.

4. The controller as recited in claim 1 further including a processor configured to operate said HVAC system according to said program schedule event and said at least one comfort sensor.

5. The controller as recited in claim 4 wherein said processor is configured to operate said HVAC system according to said program schedule event and a temperature determined by said at least one comfort sensor.

6. The controller as recited in claim 1 wherein said HVAC system is a non-zoned HVAC system.

7. The controller as recited in claim 1 wherein said memory is further configured to associate multiple program schedule events to comfort sensors of said enclosed space.

8. The controller as recited in claim 7 wherein said multiple program schedule events are selected from the group consisting of:
wake,
morning,
leave,
return,
evening, and
sleep.

9. The controller as recited in claim 1 wherein said memory is configured to associate said comfort sensor of said enclosed space to multiple program schedule events.

10. The controller as recited in claim 1 wherein said memory is configured to associate multiple comfort sensors of said enclosed space to said program schedule event.

11. The controller as recited in claim 10 further comprising a processor configured to operate said HVAC system according to said program schedule event and said multiple comfort sensors.

12. A computer-usable medium having non-transitory computer readable instructions stored thereon for execution by a processor to perform a method for operating a heating, ventilating and cooling (HVAC) system of an enclosed space, comprising:
receiving programming data that indicates an association of at least one comfort sensor of said enclosed space to a program schedule event of said HVAC system; and
assigning said at least one comfort sensor to said program schedule event.

13. The computer-usable medium as recited in claim 12 wherein said method further includes operating said HVAC system based on said program schedule event and said at least one comfort sensor.

14. The computer-usable medium as recited in claim 13 wherein said operating is based on comfort data determined by said at least one comfort sensor.

15. The computer-usable medium as recited in claim 12 wherein said programming data indicates an association of multiple comfort sensors of said enclosed space to said program schedule event and said assigning includes assigning said multiple comfort sensors to said program schedule event.

16. The computer-usable medium as recited in claim 15 wherein said method further includes operating said HVAC system based on said program schedule event and said multiple comfort sensors.

17. The computer-usable medium as recited in claim 12 wherein said programming data indicates an association of multiple program schedule events to multiple comfort sensors of said enclosed space and said assigning includes assigning said multiple comfort sensors to said multiple program schedule events.

18. The computer-usable medium as recited in claim 12 wherein said assigning includes mapping said comfort sensor to said program schedule event in a data table.

19. A heating, ventilating and air conditioning (HVAC) system, comprising:
heating, cooling and blowing (HCB) components; and
a controller coupled to said HCB components and configured to manage operation thereof, said controller comprising:
a memory configured to associate a program schedule event for said HVAC system to at least one comfort sensor of said enclosed space; and
a processor configured to operate said HVAC system according to said program schedule event and said at least one comfort sensor.

20. The HVAC system as recited in claim 19 wherein said HVAC system is a non-zoned system.
